(19) United States
(12) Patent Application Publication
(10) Pub. No.: US 2025/0059367 A1
(43) Pub. Date: Feb. 20, 2025

(54) POLYURETHANE FOAM COMPOSITION WITH EXCELLENT FLAME RETARDANCY, POLYURETHANE FOAM CONTAINING SAME, AND AUTOMOTIVE INTERIOR MATERIAL

(71) Applicants: HYUNDAI MOTOR COMPANY, Seoul (KR); Kia Corporation, Seoul (KR); Chin Yang Co., Ltd., Yangsan-si (KR)

(72) Inventors: Byung Guk Lim, Seoul (KR); Young Tae Cho, Busan (KR); Won Suck Choi, Gimhae-si (KR); Sung Yoon Lee, Yangsan-si (KR)

(73) Assignees: HYUNDAI MOTOR COMPANY, Seoul (KR); Kia Corporation, Seoul (KR); Chin Yang Co., Ltd., Yangsan-si (KR)

(21) Appl. No.: 18/416,409

(22) Filed: Jan. 18, 2024

(30) Foreign Application Priority Data
Aug. 11, 2023 (KR) 10-2023-0105589

(51) Int. Cl. C08L 75/04; B01J 31/02; B01J 31/04; C08K 5/00

(52) U.S. Cl. CPC C08L 75/04; B01J 31/0237; B01J 31/04; C08K 5/0066; C08K 2201/005; C08L 2201/02; C08L 2203/14

(57) ABSTRACT

Provided are a polyurethane foam composition with excellent flame retardancy, a polyurethane foam containing the same, and an automotive internal material. Specifically, the polyurethane foam composition, according to an exemplary embodiment of the present disclosure, contains: 50 to 70 wt % of a polyol mixture containing a polyol, a phosphorus-based flame retardant containing hydroxyl groups (—OH) at both terminals, a carbon-based flame retardant, a foaming agent, and an additive; and 30 to 50 wt % of an isocyanate.

### CROSS REFERENCE TO RELATED APPLICATION

The present application claims priority to Korean Patent Application No. 10-2023-0105589, filed Aug. 11, 2023, the entire contents of which is incorporated herein for all purposes by this reference.

### BACKGROUND OF THE PRESENT DISCLOSURE

### Field of the present disclosure

The present disclosure relates to a polyurethane foam composition with excellent flame retardancy, a polyurethane foam containing the same, and an automotive internal material.

### Description of Related art

Automotive internal seats serve to provide satisfactory and comfortable experiences to passengers in vehicles. Flexible polyurethane foam applied to the seats is a material attached to a seat cover or seat foam pad, which acts to lower body pressure in areas making contact with the passenger's body and help realize a soft feel.

The flexible polyurethane foam is classified into slabstock foam and mold foam depending on the manufacturing method. Slabstock foam refers to a foam that is used by cutting foam cured through free foaming into a desired form without injecting the raw solution into a mold. The flame retardant property is one of the property requirements because the slabstock polyurethane foam is used mainly as an indoor internal material.

On the other hand, there has recently been a growing demand for hygiene in automotive materials with which passengers come into close contact, leading to a need for washability of automotive internal seats.

However, in the case of conventional flexible polyurethane foams for automotive seats, the flame retardancy is deteriorated drastically when washing progresses and is thus unable to satisfy the safety regulations on vehicle fires.

In addition, in the case of existing flexible polyurethane foams for automotive seats, flame retardancy is obtained by physically dispersing liquid halogen-based phosphate ester, a chemical organic flame retardant, in a polyurethane matrix. However, the polar phosphate ester is lost as washing progresses, resulting in a deterioration of flame retardancy depending on the number of wash cycles.

Therefore, due to the above background, there is a growing need for research on polyurethane foams with excellent flame retardancy even after washing.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a polyurethane foam with excellent flame retardancy even after washing by preventing flame retardant components from being lost during washing.

Objectives of the present disclosure are not limited to the objectives mentioned above. The above and other objectives of the present disclosure will become more apparent from the following description, and will be realized by the means of the appended claims, and combinations thereof.

A polyurethane foam composition, according to an exemplary embodiment of the present disclosure, contains: 50 to 70 wt % of a polyol mixture containing a polyol, a phosphorus-based flame retardant containing hydroxyl groups (—OH) at both terminals, a carbon-based flame retardant, a foaming agent, and an additive; and 30 to 50 wt % of an isocyanate.

The polyol mixture may contain: 75 to 95 wt % of the polyol; 5 to 20 wt % of the phosphorus-based flame retardant; 3 to 10 wt % of the carbon-based flame retardant; 0.5 to 5 wt % of the foaming agent; and 1 to 2 wt % of the additive, with respect to the total weight of the polyol mixture.

The polyol may contain: a first polyol including a first polyether polyol containing 2 to 4 hydroxyl groups and 5 to 20 wt % of ethylene oxide (EO) with respect to the total weight of the polyether polyol, wherein the polyether polyol having a weight average molecular weight (Mw) in a range of 2,000 to 4,000 g/mol and a hydroxyl value in a range of 40 to 60 mg KOH/g; a second polyol including a second polyether polyol having a hydroxyl value in a range of 20 to 40 mg KOH/g and a non-volatile phase in an amount of 10 to 60 wt %; and a third polyol containing 5 to 7 hydroxyl groups and having a weight average molecular weight (Mw) in a range of 2,000 to 4,000 g/mol.

The polyol may contain: 20 to 60 wt % of the first polyol, 20 to 60 wt % of the second polyol; and 5 to 20 wt % of the third polyol, with respect to the total weight of the polyol.

The phosphorus-based flame retardant may have a phosphorous content in a range of 10 to 20 wt % with respect to the total weight of the phosphorus-based flame retardant.

The phosphorus-based flame retardant may have a hydroxyl value in a range of 400 to 500 mg KOH/g.

The carbon-based flame retardant may have a particle size of 0.177 mm or less.

The carbon-based flame retardant may have a carbon content in a range of 90% or more with respect to the total weight of the carbon-based flame retardant, and an expansion rate of 250% or more.

The isocyanate may include at least one selected from the group consisting of toluene diisocyanate (TDI), methylene diphenyl diisocyanate (MDI), hexamethylene diisocyanate (HDI), isophorone diisocyanate (IPDI), dicyclohexylmethane diisocyanate (H12MDI), and combinations thereof.

The additive may contain a silicone surfactant and a catalyst. In addition, the additive may contain: 0.5 to 1 wt % of the silicone surfactant; and 0.1 to 0.5 wt % of the catalyst, with respect to the total weight of the polyol mixture.

The catalyst may include at least one selected from the group consisting of triethylenediamine, triethylamine, stannous octoate, and combinations thereof.

In addition, a polyurethane foam, according to an exemplary embodiment of the present disclosure, contains the polyurethane foam composition.

In addition, an automotive internal material, according to an exemplary embodiment of the present disclosure, contains the polyurethane foam.

According to an exemplary embodiment of the present disclosure, flame retardant components can be prevented from being lost during washing by mixing a polyol, a phosphorus-based flame retardant containing hydroxyl groups (—OH) at both terminals, a carbon-based flame retardant, an isocyanate, a foaming agent, and an additive in appropriate amounts. As a result, polyurethane foam in which the flame retardancy is excellent even after washing can be prepared.

According to an exemplary embodiment of the present disclosure, washable polyurethane foam with good flame retardancy and heat resistance can be prepared by introducing two types of flame retardants that differ in properties into a basic method of manufacturing polyurethane foam.

Effects of the present disclosure are not limited to the effect mentioned above. It should be understood that the effects of the present disclosure include all the effects which can be deduced from the following description.

### BRIEF DESCRIPTION OF THE DRAWINGS

FIG. 1 shows evaluation results of the heat aging properties of polyurethane foams according to examples and comparative examples.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments. On the contrary, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Above objectives, other objectives, features, and advantages of the present disclosure will be readily understood from the following exemplary embodiments associated with the accompanying drawings. However, the present disclosure is not limited to the embodiments described herein and may be embodied in other forms. The embodiments described herein are provided so that the present disclosure can be made thorough and complete and that the spirit of the present disclosure can be fully conveyed to those skilled in the art.

It will be further understood that the terms “comprises”, “includes”, or “has” when used in the present specification specify the presence of stated features, regions, integers, steps, operations, elements, and/or components, but do not preclude the presence or addition of one or more other features, regions, integers, steps, operations, elements, components and/or combinations thereof.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is included in the present specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, the variable will be understood to include all values within the stated range, including the stated endpoints of the range. For example, a range of “5 to 10” includes values of 5, 6, 7, 8, 9, and 10, as well as any subranges such as 6 to 10, 7 to 10, 6 to 9, and 7 to 9. It will be understood to include any value between reasonable integers within the scope of the stated range, such as 5.5, 6.5, 7.5, 5.5 to 8.5, and 6.5 to 9. In addition, for example, a range of “10% to 30%” includes values such as 10%, 11%, 12%, 13%, and all integers up to and including 30%, as well as any subranges such as 10% to 15%, 12% to 18%, and 20% to 30%. It will be understood to include any value between reasonable integers within the scope of the stated range, such as 10.5%, 15.5%, 25.5%.

The present disclosure relates to a polyurethane foam composition with excellent flame retardancy.

A polyurethane foam composition, according to an exemplary embodiment of the present disclosure, contains: 50 to 70 wt % of a polyol mixture containing a polyol, a phosphorus-based flame retardant containing hydroxyl groups (—OH) at both terminals, a carbon-based flame retardant, a foaming agent, and an additive; and 30 to 50 wt % of an isocyanate.

Hereinafter, each component constituting the polyurethane foam composition, according to an exemplary embodiment of the present disclosure, will be described in more detail as follows.

### Polyol Mixture

The polyurethane foam composition, according to an exemplary embodiment of the present disclosure, may contain 50 to 70 wt % of the polyol mixture with respect to the total weight thereof.

The polyol mixture may include the polyol, the phosphorus-based flame retardant containing hydroxyl groups (—OH) at both terminals, the carbon-based flame retardant, the foaming agent, and the additive.

### (A) Polyol

The polyol may be contained in an amount of 75 to 95 wt % with respect to 100 wt % of the polyol mixture.

The polyol may contain: 20 to 60 wt % of a first polyol; 20 to 60 wt % of a second polyol; and 5 to 20 wt % of a third polyol, with respect to the total weight thereof.

In the present disclosure, the first polyol is used to control the overall physical properties of the final product. The first polyol may include a first polyether polyol containing 2 to 4 hydroxyl groups and 5 to 20 wt % of ethylene oxide (EO) with respect to the total weight of the polyether polyol, the polyether polyol having a weight average molecular weight (Mw) in a range of 2,000 to 4,000 g/mol and a hydroxyl value in a range of 40 to 60 mg KOH/g.

In the present disclosure, the second polyol is used to improve the hardness of the final product, which is the polyurethane foam. The second polyol may have a hydroxyl value in a range of 20 to 40 mg KOH/g and contain 10 to 60 wt % of a non-volatile phase.

When the amount of the second polyol exceeds 60 wt %, the hardness of the polyurethane foam becomes excessively high, so passengers may complain of discomfort while sitting on the seat. Therefore, the amount of the second polyol used is preferably less than 60 wt % with respect to 100 wt % of the polyol mixture.

In the present disclosure, the third polyol serves to maximize the elasticity of the final product. The third polyol may be the second polyol including the polyether polyol having a hydroxyl value in a range of 20 to 40 mg KOH/g and containing 10 to 60 wt % of a non-volatile phase, which may have a weight average molecular weight (Mw) in a range of 2,000 to 4,000 g/mol and contain 5 to 7 hydroxyl groups.

### (B) Phosphorus-Based Flame Retardant

Phosphorus-based flame retardants are reactive substances that undergo reactions with other polyols, isocyanates, and water to form a polyurethane network structure.

To prevent a flame retardant from being lost in polyurethane foam after washing, the flame retardant must have good flame retardancy while being adsorbed or dispersed on the polyurethane surface so as not to be present in a form that is easy to be washed off.

On the other hand, the phosphorus-based flame retardant used herein contains hydroxyl groups (—OH) at both terminals and has a form in which phosphorus is bonded to the middle of the polyol, serving as the main foaming material.

Specifically, the phosphorus-based flame retardant may contain two or more functional groups and have a phosphorus content in a range of 10 to 20 wt % with respect to the total weight of the phosphorus-based flame retardant and a hydroxyl value in a range of 400 to 500 mg KOH/g.

The phosphorus-based flame retardant may be represented by a structural formula as shown in Formula 1 below. In the instant case, n may be a number that falls within an appropriate range depending on the molecular weight.

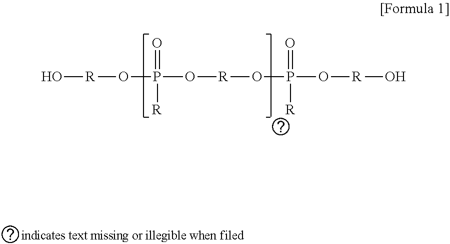

The phosphorus-based flame retardant may be contained in an amount of 5 to 20 wt % with respect to 100 wt % of the polyol mixture.

When the amount of the phosphorus-based flame retardant is less than 5 wt %, the flame retardant effect is insignificant, which is inappropriate. On the contrary, when the amount of the phosphorus-based flame retardant exceeds 20 wt %, the excessively added amount may lead to a deterioration of the physical properties (such as elasticity, hardness, and the like) of the polyurethane foam. In addition, there may be a problem in that a closed cell structure is formed, resulting in shrinkage.

On the other hand, in polyurethane foam, existing TCEP-based flame retardants may show excellent performance in terms of flame retardant performance and property maintenance. However, existing TCEP-based flame retardants are dispersed without being chemically bonded to polyurethane and thus are vulnerable in terms of heat resistance. In addition, most of the flame retardant components are lost during washing, so the flame retardant performance may be unable to be maintained after washing.

Therefore, in an exemplary embodiment of the present disclosure, the phosphorus-based flame retardant undergoes reactions with other polyols, isocyanate, and water to form the polyurethane network structure, maintaining flame retardant performance in the final product, the polyurethane foam, even after washing.

Therefore, in an exemplary embodiment of the present disclosure, a phosphorus (P) compound having a form in which hydroxyl groups are introduced into both terminals is used as the phosphorus-based flame retardant to chemically bond to the polyurethane foam matrix. As a result, the flame retardant in the polyurethane foam may be prevented from being lost after washing.

### (C) Carbon-Based Flame Retardant

In the present disclosure, the carbon-based flame retardant is used to supplement the flame retardant performance of the phosphorus-based flame retardant. The carbon-based flame retardant is environmentally friendly compared to existing TCEP-based flame retardants, which is advantageous.

In the carbon-based flame retardant, oxidized expandable graphite may be used.

The carbon-based flame retardant may expand at a predetermined or higher temperature to block heat and oxygen. In addition, the carbon-based flame retardant may have a carbon content of 90% or more with respect to the total weight of the carbon-based flame retardant, and an expansion rate of 250% or more. The carbon content may be in a range of 90% to 98%, and the expansion rate may be in a range of 250% to 350%.

Typically, the larger the particle size, the better the flame retardant performance of the carbon-based flame retardant. However, the carbon-based flame retardant having a particle size of 0.177 mm or less, according to an exemplary embodiment of the present disclosure, may be used to obtain flame retardant performance in the polyurethane foam. When the particle size of the carbon-based flame retardant exceeds 0.177 mm, the expansion rate may be low, resulting in a relatively poor flame retardant performance. Accordingly, there may be a case where an excessive amount of the carbon-based flame retardant needs to be added, which is undesirable.

Therefore, excessive amounts of raw materials, other than the main raw material, used when foaming the polyurethane foam may result in shrinkage or a deterioration of the physical properties. For this reason, it is preferable to optimize deterioration of the physical properties by adjusting the particle size of the carbon-based flame retardant to be 0.177 mm or less.

The carbon-based flame retardant may be contained in an amount of 3 to 10 wt % with respect to 100 wt % of the polyol mixture.

When the amount of the carbon-based flame retardant is less than 3 wt %, the flame retardant effect may be insignificant, which is inappropriate. On the other hand, when the amount of the carbon-based flame retardant exceeds 10 wt %, the excessive amount used may result in shrinkage and deterioration of the physical properties.

Therefore, the carbon-based flame retardant is characterized by rapidly expanding during combustion and having a physical flame retardation mechanism that forms char and blocks oxygen. For this reason, when used with the phosphorus-based flame retardant described above, a higher level of flame retardant performance may be obtained through synergy between the physical and chemical flame retardation mechanisms.

### (D) Foaming Agent

As the foaming agent, any known foaming agent commonly used in the field of foam technology may be used in an amount within a range that does not impair the effect of the present disclosure.

As the foaming agent, water may be typically used. In addition, at least one selected from among methylene chloride, n-butane, isobutane, n-pentane, isopentane, dimethyl ether, acetone, carbon dioxide, and the like may be used. Such foaming agents may be appropriately selected and used according to known usage methods and depending on the required density or other properties of the foam.

Therefore, in an exemplary embodiment of the present disclosure, the amount of the foaming agent used is not particularly limited. However, if necessary, the foaming agent may be used in an amount within the range of 0.5 to 5 wt % with respect to 100 wt % of the polyol mixture.

### (E) Additive

The additive is a component used to provide various functions to the polyurethane adhesive composition. As the additive, any known additives may be used without particular limitation in an amount within a range that does not impair the effect of the present disclosure.

Therefore, in an exemplary embodiment of the present disclosure, the amount of the additive used is not particularly limited. However, if necessary, the additive may be used in an amount within the range of 1 to 2 wt % with respect to 100 wt % of the polyol mixture.

The additives may include a silicone surfactant and a catalyst.

The silicone surfactant serves to prevent generated cells from coalescing or being destroyed during cell formation inside the polyurethane foam and to control the formation of cells to obtain uniform shapes and sizes. The silicone surfactant may be one or more types selected from among polysiloxanes, silicone oils, derivatives thereof, and the like.

The silicone surfactant may be used in an amount of 0.5 to 1 wt % with respect to 100 wt % of the polyol mixture. In the instant case, when the amount of the silicone surfactant used is excessively small, there is a problem in that the foam is non-uniformly molded. On the contrary, when the amount of silicone surfactant used is excessively large, there may be fatal problems, such as shrinkage of the foam and deterioration of flame retardant properties.

The catalyst is not particularly limited, and any known catalysts commonly used in the field of foam technology may be used. The catalyst serves to promote the reaction between the polyol and an isocyanate compound.

For example, at least one selected from the group consisting of amine catalysts, such as triethylenediamine, triethylamine, and the like, organotin catalysts, such as stannous octoate, and combinations thereof may be used as the catalyst.

The catalyst may be contained in an amount of 0.1 to 0.5 wt % with respect to 100 wt % of the polyol mixture. When the amount of the catalyst used is excessively small, there may be a problem in that the reaction is delayed, resulting in curing failure. On the contrary, when the amount of the catalyst used is excessively large, shrinkage or cracks may occur in the foam.

### Isocyanate

The isocyanate is an essential component added when manufacturing the polyurethane foam and serves to cause a chemical reaction with the polyol mixture. The isocyanate may serve to make the distribution of hard segments and soft segments within the polyurethane structure uniform through the chemical reaction of the polyol.

The isocyanate may be contained in an amount of 30 to 50 wt % with respect to the total weight of the polyurethane foam composition according to an exemplary embodiment of the present disclosure.

As the isocyanate, any known isocyanate may be used without particular limitation in an amount within a range that does not impair the effect of the present disclosure. For example, the isocyanate may include at least one selected from the group consisting of toluene diisocyanate (TDI), methylene diphenyl diisocyanate (MDI), hexamethylene diisocyanate (HDI), isophorone diisocyanate (IPDI), dicyclohexylmethane diisocyanate (H12MDI), and combinations thereof. Preferably, toluene diisocyanate may be used as the isocyanate.

From another perspective, the present disclosure relates to a polyurethane foam. The polyurethane foam, according to an exemplary embodiment of the present disclosure, contains the polyurethane foam composition described above.

From a further perspective, the present disclosure relates to an automotive internal material. The automotive internal material, according to an exemplary embodiment of the present disclosure, contains the polyurethane foam described above.

Accordingly, the polyurethane foam, according to an exemplary embodiment of the present disclosure, may be used in a wide range of applications, but may be used in the automotive field.

Therefore, the polyurethane foam, according to an exemplary embodiment of the present disclosure, is effectively usable as automotive seat foam that requires excellent flame retardancy even after washing.

In addition, the present disclosure may be applied to a washable seat cover through combination with a fabric or leather material capable of maintaining combustibility after washing.

In addition, in an exemplary embodiment of the present disclosure, heat resistance is superior to that of existing flexible polyurethane foams for automotive seats. Thus, there may be an effect of improving long-term durability when applied to heated seats with warmers or steering wheels.

Hereinafter, the present disclosure will be described in more detail through specific examples. The following examples are only examples to help the understanding of the present disclosure, and the scope of the present disclosure is not limited thereto.

The component contents of polyols used in examples are shown in Table 1 below. In addition, the component contents of polyol mixtures containing the respective polyols are shown in Table 2 below.

The polyol mixtures were prepared using the respective component contents according to Table 2 below. Each polyol mixture was mixed with an isocyanate in a weight ratio of 62:38 to prepare a composition for manufacturing polyurethane foam. In the instant case, toluene diisocyanate (TDI) was used as the isocyanate.

TABLE 1

| Component | | Comparative Example | | | | | | | Example | | | |
|---|---|---|---|---|---|---|---|---|---|---|---|---|
| (wt %) | | 1 | 2 | 3 | 4 | 5 | 6 | 7 | 1 | 2 | 3 | 4 |
| (A) | First | 60 | 50 | 50 | 50 | 50 | 50 | 50 | 50 | 50 | 50 | 50 |
| Polyol | polyol | | | | | | | | | | | |
| | Second | 40 | 45 | 45 | 45 | 45 | 45 | 45 | 45 | 45 | 45 | 45 |
| | polyol | | | | | | | | | | | |
| | Third | 0 | 5 | 5 | 5 | 5 | 5 | 5 | 5 | 5 | 5 | 5 |
| | polyol | | | | | | | | | | | |

| | | | | | | | | | | | |
|---|---|---|---|---|---|---|---|---|---|---|---|
| Sum | 100 | 100 | 100 | 100 | 100 | 100 | 100 | 100 | 100 | 100 | 100 |

Comparative Example 1 is existing technology.
[Components]
(A) Polyol
First polyol: A polyether polyol containing 3 hydroxyl groups and 5 to 20 wt % of ethylene oxide (EO), the polyether polyol having a hydroxyl value of 56 mg KOH/g and a weight average molecular weight (Mw) of 3000 g/mol (manufacturer: KPX Chemicals)
Second polyol: A polymer polyol having a hydroxyl value of 30 mg KOH/g and an average non-volatile phase of 48 wt % (manufacturer: KPX Chemicals)
Third polyol: A highly functional polyol having a weight average molecular weight (Mw) of 3000 g/mol and containing 5 to 7 hydroxyl groups (manufacturer: KPX Chemicals)

TABLE 2

| Component | | Comparative Example | | | | | | | Example | | | |
|---|---|---|---|---|---|---|---|---|---|---|---|---|
| (wt %) | | 1 | 2 | 3 | 4 | 5 | 6 | 7 | 1 | 2 | 3 | 4 |
| (A) Polyol | | 80.39 | 89.86 | 87.5 | 80.48 | 91.52 | 89.06 | 87.5 | 83.85 | 81.77 | 80.48 | 78.56 |
| (B) Flame | TCEP- | 16.08 | 0.00 | 0.00 | 0.00 | 0.00 | 0.00 | 0.00 | 0.00 | 0.00 | 0.00 | 0.00 |
| retardant | based flame | | | | | | | | | | | |
| | retardant | | | | | | | | | | | |
| | Phosphorus- | 0.00 | 6.29 | 8.75 | 16.09 | 0.00 | 0.00 | 0.00 | 8.38 | 10.63 | 12.07 | 14.14 |
| | based flame | | | | | | | | | | | |
| | retardant | | | | | | | | | | | |
| | Carbon- | 0.00 | 0.00 | 0.00 | 0.00 | 4.58 | 7.13 | 8.75 | 4.19 | 4.09 | 4.02 | 3.93 |
| | based flame | | | | | | | | | | | |
| | retardant | | | | | | | | | | | |
| (C) Foaming agent | | 2.33 | 2.61 | 2.54 | 2.33 | 2.65 | 2.58 | 2.54 | 2.43 | 2.37 | 2.33 | 2.28 |
| (D) Surfactant | | 0.80 | 0.81 | 0.79 | 0.72 | 0.82 | 0.80 | 0.79 | 0.75 | 0.74 | 0.72 | 0.71 |
| (E) | Catalyst A | 0.08 | 0.09 | 0.09 | 0.08 | 0.09 | 0.09 | 0.09 | 0.08 | 0.08 | 0.08 | 0.08 |
| Catalyst | Catalyst B | 0.24 | 0.27 | 0.26 | 0.24 | 0.27 | 0.27 | 0.26 | 0.25 | 0.25 | 0.24 | 0.24 |
| | Catalyst C | 0.08 | 0.07 | 0.07 | 0.06 | 0.07 | 0.07 | 0.07 | 0.07 | 0.07 | 0.06 | 0.06 |

| | | | | | | | | | | | |
|---|---|---|---|---|---|---|---|---|---|---|---|
| Sum | 100 | 100 | 100 | 100 | 100 | 100 | 100 | 100 | 100 | 100 | 100 |

Comparative Example 1 is existing technology.
[Components of polyol mixture]
(B) Flame retardant
TCEP-based flame retardant: Tris(2-chloroethyl) phosphate flame retardant, CR-530 product (manufacturer: DAIHACHI)
Phosphorus-based flame retardant: A phosphorus-based flame retardant having a phosphorus content in a range of 10 to 20 wt % and a hydroxyl value in a range of 400 to 500 mg KOH/g, Exolit ®OP560 product (manufacturer: CLARIANT)
Carbon-based flame retardant: Graphite oxide, HD 350 80 product having a particle size of 0.177 mm or less, a carbon content of 90% or more, and an expansion rate of 250% or more (manufacturer: Samjeong C&G)
(C) Foaming agent: Water
(D) Surfactant: A silicone-based surfactant
(E) Catalyst:
Catalyst A: A blow catalyst containing triethylamine as the main component
Catalyst B: A gel catalyst containing triethylamine as the main component
Catalyst C: An organotin catalyst

Next, each composition was foamed, as follows, to prepare polyurethane foam specimens for seats.

Specifically, each polyurethane foam specimen was stirred at about 2,000 rpm for about 10 seconds after compounding each component, injected into a mold made of wood, aged after carbon dioxide was generated, and stored for 1 day in a place where constant temperature and humidity were maintained. Then, the physical properties were measured in accordance with MS200-34, the physical property standard for urethane foam. Specifically, the apparent density, related to the weight and physical properties of the foam, was set to be at a level of 32 +3 kg/m3 with respect to the core density measured from a sample cut from the pad. In addition, the physical properties were measured under the conditions meeting the basic performance required for the seat component unit.

The physical properties of each polyurethane foam specimen manufactured in the same manner as above were confirmed by the following method.

### Experimental Example 1—Changes in Physical Properties Before and After Washing

First, to confirm differences in changes in the physical properties of the polyurethane foams according to examples and comparative examples before and after washing, measurements of combustion rate, density, and hardness before and after washing were performed on the specimens manufactured using the compositions, according to examples and comparative examples, by the evaluation methods according to the following items. The results thereof are shown in Table 4 below.

### [Evaluation Method]

Hardness (kPa): The hardness of the specimen was measured at room temperature (25° C.) using a hardness measuring device (UTM) on the basis of KS M ISO 6672.

Specifically, each specimen having a size of 300×300 and a thickness of 50 mm was fixed in a fixture jig. Then, a load was applied to a pressure plate at a speed of 50 mm/min so that the specimen was compressed to have a quarter of the original thickness. When 20 seconds elapsed, the pressure (kPa) value was measured.

(2) Apparent density: The apparent density was calculated according to Equation 1 after measuring the weight and volume of the test specimen on the basis of KS M ISO 6672. However, the results are expressed as the average value of the three specimens.

$$A = W / V \qquad [ Equation 1 ]$$

Here, A stands for the apparent density (g/cm³), V stands for the volume (cm³), and W stands for the weight (g).

(3) Combustibility: A combustibility test was conducted after performing a washing test only on specimens that satisfied combustibility before washing. In the combustibility test, the combustion rate was measured on the basis of the MS300-08 standard developed by Hyundai Motor Company. Here, SE stands for self-extinguished.

(4) Washing method: The washing method was performed up to 5 times on the basis of KS K ISO 6330 (Textile-Domestic washing and drying procedures for textile testing). Specific washing conditions are shown in Table 3 below.

TABLE 3

| Standard | | | | | |
|---|---|---|---|---|---|
| number | Standard name | Washing | Drying | Reference detergent | |
| ISO 6330 | Washing and drying | Type A (front- | Tumble | 1 (for Type B) | 4 (for Type |
| | procedures | loading | dryer | | C) |
| | (domestic washing | washer) | | | |
| | and drying | Type B (top- | Line drying | 2 (with | 5 (for Type |
| | processes) | loading | (vertical | whitening | B) |
| | | agitator-type | type) | agent) | |
| | | washer) | | | |
| | | Type C (top- | Drying rack | 3 (without | 6 (with |
| | | loading | (horizontal | whitening | whitening |
| | | pulsator-type | type) | agent) | agent) |
| | | washer) | | | |

TABLE 4

| | Comparative Example | | | | | | | Example | | | |
|---|---|---|---|---|---|---|---|---|---|---|---|
| Properties | 1 | 2 | 3 | 4 | 5 | 6 | 7 | 1 | 2 | 3 | 4 |
| Combustion rate | SE | burnt | 200 | 48 | SE | SE | SE | SE | SE | SE | SE |
| before washing | | out | | | | | | | | | |
| (mm/min) | | | | | | | | | | | |
| Combustion rate | 31 | burnt | burnt | SE | SE | SE | SE | SE | SE | SE | SE |
| after one wash | | out | out | | | | | | | | |
| (mm/min) | | | | | | | | | | | |
| Combustion rate | 52 | burnt | burnt | SE | SE | SE | SE | SE | SE | SE | SE |
| after two washes | | out | out | | | | | | | | |
| (mm/min) | | | | | | | | | | | |
| Combustion rate | 78 | burnt | burnt | 150 | 122 | 115 | SE | SE | SE | SE | SE |
| after three | | out | out | | | | | | | | |
| washes (mm/min) | | | | | | | | | | | |
| Combustion rate | 120 | burnt | burnt | 192 | 148 | 122 | 80 | SE | SE | SE | SE |
| after four washes | | out | out | | | | | | | | |
| (mm/min) | | | | | | | | | | | |
| Combustion rate | 148 | burnt | burnt | 198 | 138 | 185 | 85 | 9 | 10 | 7 | SE |
| after five washes | | out | out | | | | | | | | |
| (mm/min) | | | | | | | | | | | |
| Density (kg/m³) | 34.2 | 34.2 | 34.6 | 34.0 | 30.1 | 30.3 | 30.3 | 30.2 | 29.8 | 29.8 | 30.0 |
| Hardness | 17.9 | 17.8 | 17.7 | 18.1 | 10.5 | 10.5 | 10.5 | 10.2 | 10.9 | 10.9 | 10.9 |
| (kgf/314 cm²) | | | | | | | | | | | |

First, in Comparative Example 1, the TCEP-based flame retardant used in existing automotive seat foam was applied.

Referring to the results in Table 4, the combustion rate of Comparative Example 1, using the TCEP-based flame retardant, satisfies the standard material requirements developed by Hyundai Motor Company and domestic/international safety regulations, before washing. However, in Comparative Example 1, the combustion rate increases as washing progresses. As a result, when performing washing three or more times, the combustion rate that no longer satisfies the regulations and the standard material requirements is exhibited.

This is because the liquid-type flame retardant having a low molecular weight is physically dispersed within the polyurethane matrix due to the properties of the TCEP-based flame retardant used in Comparative Example 1. Thus, as washing progresses, the amount of the flame retardant in the polyurethane decreases.

In addition, Comparative Examples 2 to 4, using only the phosphorus-based flame retardant instead of the TCEP-based flame retardant, were manufactured to achieve a density within a range of 32±3 kg/m³ and a hardness within a range of 16±2 kgf/314 cm² that were at equivalent levels to those of Comparative Example 1, the existing technology.

Accordingly, when using the phosphorus-based flame retardant alone, the combustion rate was shown at a level equivalent to that of Comparative Example 1 only when adding the flame retardant in an amount of 16 wt % or more with respect to 100 wt % of the polyol mixture, as in Comparative Example 4.

On the other hand, in Comparative Example 4, it was seen that the flame retardant performance after washing was deteriorated when performing washing three or more times.

In addition, Comparative Examples 5 to 7, using only the carbon-based flame retardant instead of the TCEP-based flame retardant, were manufactured to achieve the equivalent level as in Comparative Example 1, the existing technology.

Accordingly, when using the carbon-based flame retardant alone, the density was slightly reduced when adding the flame retardant in an amount of 4.5 wt % or more with respect to 100 wt % of the polyol mixture. In addition, it was seen that the more the amount of the carbon-based flame retardant, the lower the hardness.

This seems to be because the carbon-based flame retardant combines with the isocyanate instead of the polyol, preventing the formation of polyurethane bonds that allow hardness to be achieved.

In addition, it was seen that in Comparative Examples 4 to 7, the flame retardant performance after washing was deteriorated when performing washing three times or more times.

On the other hand, in Examples 1 to 4, in which the carbon-based flame retardant and the phosphorus-based flame retardant were added in appropriate amounts, the combustion rate did not increase even after washing, confirming that the flame retardant performance was maintained even after washing. It was seen that due to the synergistic effect of radical scavenger and char formation, which are the flame retardation mechanisms of the two flame retardants, the flame retardant performance was greatly improved when using both the flame retardants compared to when using either one of the flame retardants.

### Experimental Example 2—Heat Aging Evaluation

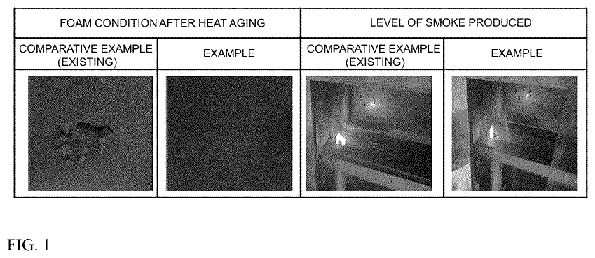

Next, to confirm the heat aging properties of the specimens manufactured using the compositions according to the examples and comparative examples, evaluation was performed on the specimens manufactured using the compositions according to the Examples and Comparative Examples by the evaluation method according to the following items. The results thereof are shown in Table 5 and FIG. 1 below.

### [Evaluation Method]

Hardness and density: The measurements were performed in the same manner as in the physical property measurement.

Permanent shrinkage rate: The thickness of each specimen having a size of 50×50 mm and a thickness in a range of 20 to 50 mm was measured at the center portion. Next, a parallel compression plate was used to compress and fix the specimen to have 70% of the original thickness. The specimen was then kept at a measurement temperature for 22 hours. Subsequently, after leaving the specimen at room temperature for 30 minutes, the thickness of the specimen at the same location was measured. Lastly, the permanent shrinkage rate was calculated according to Equation 2 below.

$$CS = [ ( {T}_{0} - {T}_{1} ) / {T}_{0} ] \times 100 \qquad [ Equation 2 ]$$

Here, CS stands for the compression set (%), To stands for the initial thickness of the test specimen (mm), and Tl stands for the thickness (mm) of the test specimen after the test.

(3) Heat aging properties: The test specimen whose hardness was measured was aged for 22 hours in a constant temperature bath maintained at 80° C. and left at room temperature for 1 hour. Then, the hardness was measured to obtain the rate of hardness change according to Equation 3 below. However, the results are expressed as the average of the three specimens.

$$DS = [ ( S - {S}_{0} ) / {S}_{0} \times 100 \qquad [ Equation 3 ]$$

Here, DS stands for the rate of hardness change (%), So stands for the average value of hardness before heating (kgf), and S stands for the average value of hardness after heating (kgf).

TABLE 5

| | | | | Tensile | | |
|---|---|---|---|---|---|---|
| Classification | | Density | Hardness | properties | Elongation | Remarks |
| Comparative | Before | 26.3 | 13.2 | 1.2 | 165 | Flame retardant: CR-530, |
| Example 1 | After | 25.7 | Unmeasurable | 1.3 | 12 | large amount of smoke |
| (existing | | | | | | produced, crumbled |
| technology) | | | | | | |
| Example 1 | Before | 26.7 | 13.2 | 1.1 | 153 | Flame retardant: |
| | After | 26.5 | 12.1 | 1.1 | 135 | reactive + carbon-based, |
| | | | | | | small amount of smoke |
| | | | | | | produced, hardness decreased |
| | | | | | | by less than 20% compared |
| | | | | | | to results before heat aging |

FIG. 1 shows the evaluation results of the heat aging properties of the polyurethane foams according to examples and comparative examples.

Referring to Table 5 and FIG. 1, when left at 140° C. for 168 hours, it was seen that Comparative Example 1, the existing technology, crumbled due to a large amount of smoke produced. In addition, Comparative Example 1 may be considered as being practically carbonized because the elongation and hardness thereof are reduced rapidly.

On the other hand, in Example 1 according to an exemplary embodiment of the present disclosure, smoke is produced less from the polyurethane foam, and carbonization thus occurs less. As a result, the elongation and hardness are decreased by less than 20% compared to those before heat aging.

Therefore, it is seen that Example 1 also satisfies the values typically regulated by the material requirements developed by HKMC. Accordingly, the polyurethane foam, according to an exemplary embodiment of the present disclosure, is highly durable even during accelerated aging tests and has a longer service life than existing foams even under high-temperature conditions.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless particularly stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A polyurethane foam composition comprising:
50 to 70 wt % of a polyol mixture comprising:
a polyol,
a phosphorus-based flame retardant comprising hydroxyl groups (—OH) at both terminals,
a carbon-based flame retardant,
a foaming agent, and
an additive; and
30 to 50 wt % of an isocyanate.

2. The polyurethane foam composition of claim 1, wherein the polyol mixture comprises:
75 to 95 wt % of the polyol;
5 to 20 wt % of the phosphorus-based flame retardant;
3 to 10 wt % of the carbon-based flame retardant;

0. 5 to 5 wt % of the foaming agent; and
1 to 2 wt % of the additive, with respect to a total weight of the polyol mixture.

3. The polyurethane foam composition of claim 1, wherein the polyol comprises:
a first polyol comprising a first polyether polyol comprising 2 to 4 hydroxyl groups and 5 to 20 wt % of ethylene oxide (EO) with respect to a total weight of the polyether polyol, wherein the polyether polyol having a weight average molecular weight (Mw) in a range of 2,000 to 4,000 g/mol and a hydroxyl value in a range of 40 to 60 mg KOH/g;
a second polyol comprising a second polyether polyol having a hydroxyl value in a range of 20 to 40 mg KOH/g and comprising 10 to 60 wt % of a non-volatile phase; and
a third polyol comprising 5 to 7 hydroxyl groups and having a weight average molecular weight (Mw) in a range of 2,000 to 4,000 g/mol.

4. The polyurethane foam composition of claim 3, wherein the polyol comprises:
20 to 60 wt % of the first polyol;
20 to 60 wt % of the second polyol; and
5 to 20 wt % of the third polyol, with respect to a total weight of the polyol.

5. The polyurethane foam composition of claim 1, wherein the phosphorus-based flame retardant has a phosphorous content in a range of 10 to 20 wt % with respect to a total weight of the phosphorus-based flame retardant.

6. The polyurethane foam composition of claim 1, wherein the phosphorus-based flame retardant has a hydroxyl value in a range of 400 to 500 mg KOH/g.

7. The polyurethane foam composition of claim 1, wherein the carbon-based flame retardant has a particle size of 0.177 mm or less.

8. The polyurethane foam composition of claim 1, wherein the carbon-based flame retardant has a carbon content of 90% or more with respect to a total weight of the carbon-based flame retardant, and an expansion rate of 250% or more.

9. The polyurethane foam composition of claim 1, wherein the isocyanate comprises at least one selected from the group consisting of toluene diisocyanate (TDI), methylene diphenyl diisocyanate (MDI), hexamethylene diisocyanate (HDI), isophorone diisocyanate (IPDI), dicyclohexylmethane diisocyanate (H12MDI), and combinations thereof.

10. The polyurethane foam composition of claim 1,
wherein the additive comprises a silicone surfactant and a catalyst, and
wherein the additive comprises:
0.5 to 1 wt % of the silicone surfactant; and
0.1 to 0.5 wt % of the catalyst, with respect to a total weight of the polyol mixture.

11. The polyurethane foam composition of claim 10, wherein the catalyst comprises at least one selected from the group consisting of triethylenediamine, tricthylamine, stannous octoate, and combinations thereof.

12. A polyurethane foam comprising the polyurethane foam composition of claim 1.

13. An automotive internal material comprising the polyurethane foam of claim 12.
